(19) United States
(12) Patent Application Publication
(10) Pub. No.: US 2026/0072693 A1
(43) Pub. Date: Mar. 12, 2026

(54) SPECULATION BARRIER

(71) Applicant: Arm Limited, Cambridge (GB)

(72) Inventors: Abraham FERNANDEZ RUBIO, Austin, TX (US); Jose VILA BAUSILI, Pamplona (ES)

(21) Appl. No.: 18/829,530

(22) Filed: Sep. 10, 2024

(51) Int. Cl. G06F 9/30

(52) U.S. Cl. CPC G06F 9/3842; G06F 9/30058; G06F 9/30072; G06F 9/30145; G06F 9/30185; G06F 2212/1052

(57) ABSTRACT

An apparatus comprises processing circuitry configured to perform data processing and instruction decoding circuitry configured to decode instructions to control the processing circuitry to perform the data processing. The instruction decoding circuitry is responsive to a speculation barrier variant of a conditional instruction having an instruction outcome depending on a condition, to control the processing circuitry to: while the condition is not yet resolved, impose a speculation barrier requirement to restrict speculative handling of a subsequent operation appearing in program order after the speculation barrier variant of the conditional instruction, and in response to resolution of the condition, relax the speculation barrier requirement imposed by the speculation barrier variant of the conditional instruction.

### BACKGROUND

### Technical Field

The present technique relates to the field of data processing.

### Technical Background

A data processing apparatus may support speculative execution of instructions, in which instructions are executed before it is known whether input operands for the instruction are correct or whether the instruction needs to be executed at all. For example, a processing apparatus may have a branch predictor for predicting outcomes of branch instructions so that subsequent instructions can be fetched, decoded and executed speculatively before it is known what the real outcome of the branch should be.

### SUMMARY

At least some examples of the present technique provide an apparatus, comprising:
processing circuitry configured to perform data processing; and
instruction decoding circuitry configured to decode instructions to control the processing circuitry to perform the data processing; in which:
the instruction decoding circuitry is responsive to a speculation barrier variant of a conditional instruction having an instruction outcome depending on a condition, to control the processing circuitry to:
   while the condition is not yet resolved, impose a speculation barrier requirement to restrict speculative handling of a subsequent operation appearing in program order after the speculation barrier variant of the conditional instruction; and
      in response to resolution of the condition, relax the speculation barrier requirement imposed by the speculation barrier variant of the conditional instruction.

At least some examples provide a method, comprising:
decoding instructions to control processing circuitry to perform data processing; and
responsive to a speculation barrier variant of a conditional instruction having an instruction outcome depending on a condition:
   while the condition is not yet resolved, imposing a speculation barrier requirement to restrict speculative handling of a subsequent operation, appearing in program order after the speculation barrier variant of the conditional instruction; and
   in response to resolution of the condition, relaxing the speculation barrier requirement imposed by the speculation barrier variant of the conditional instruction.

At least some examples provide a computer program for controlling a host data processing apparatus to provide an instruction execution environment, the computer program comprising:
processing program logic configured to perform data processing; and
instruction decoding program logic configured to decode instructions to control the processing program logic to perform the data processing; in which:
the instruction decoding program logic is responsive to a speculation barrier variant of a conditional instruction having an instruction outcome depending on a condition, to control the processing circuitry to:
   while the condition is not yet resolved, impose a speculation barrier requirement to restrict speculative handling of a subsequent operation, appearing in program order after the speculation barrier variant of the conditional instruction; and
   in response to resolution of the condition, relax the speculation barrier requirement imposed by the speculation barrier variant of the conditional instruction.

The computer program may be stored on a computer-readable storage medium. The storage medium may be non-transitory.

Further aspects, features and advantages of the present technique will be apparent from the following description of examples, which is to be read in conjunction with the accompanying drawings.

### BRIEF DESCRIPTION OF THE DRAWINGS

FIG. 1 schematically illustrates an example of a data processing apparatus;

FIG. 2 schematically illustrates an example of a potential attack based on speculation-based cache based timing side-channels;

FIG. 3 is a flow diagram illustrating a method of using a speculation barrier variant of a conditional instruction;

FIG. 4 illustrates two example programs comprising a speculation barrier variant of a conditional instruction; and

FIG. 5 illustrates a simulation example.

### DESCRIPTION OF EXAMPLES

A data processing apparatus may have mechanisms for ensuring that some data in memory cannot be accessed by certain processes executing on the processing circuitry. For example privilege-based mechanisms and/or memory protection attributes may be used to control the access to certain regions of memory. Recently, it has been recognised that in systems using speculative execution, there is a potential for a malicious person to gain information from a region of memory that they do not have access to, by exploiting the property that the effects of speculatively executed instructions may persist in a data processing apparatus, such as in a cache, even after any architectural effects of the speculatively executed instructions have been reversed following a mis-speculation. Such attacks may train branch predictors or other speculation mechanisms to trick more privileged code into speculatively executing a sequence of instructions designed to make the privileged code access a pattern of memory addresses dependent on sensitive information, so that less privileged code which does not have access to that sensitive information can use cache timing side-channels to probe which addresses have been allocated to, or evicted from, the cache by the more privileged code, to give some information which could allow the sensitive information to be deduced. Such attacks can be referred to as speculative side-channel attacks.

A number of mitigation measures can be taken to reduce the risk of information leakage due to speculative side-channel attacks. One option is to provide a speculation barrier instruction which can be inserted into a program to restrict speculative handling of operations appearing in program order after the speculation barrier instruction which may be affected by an instruction appearing before the speculation barrier instruction, e.g., by preventing a subsequent operation having an address dependency on an earlier instruction preceding the speculation barrier instruction in the program order from speculatively influencing allocations of entries in the cache, where such allocation could be visible via a side-channel attack. A programmer could for example include such a speculation barrier instruction after a conditional instruction in a program, to prevent speculative execution of instructions dependent on the conditional instruction from being used to make sensitive information, not accessible to untrusted code, accessible via a side-channel attack.

However, a general speculation barrier instruction may have a significant impact on performance. Such an instruction may for example require that all instructions preceding the speculation barrier complete before speculative execution is permitted for instructions following the speculation barrier. The use of a global speculation barrier instruction may prevent at least some speculative execution for which there is little risk of sensitive information being leaked, and thereby negatively impact performance in a way which may not be required to maintain protection against speculative side-channel attacks.

The inventors of the present techniques have realised that for conditional instructions having an outcome depending on a condition, the risk of speculative execution of subsequent instructions enabling sensitive information to be made available via a side-channel attack may exist only while the condition is unresolved. That is, speculation of the outcome of the conditional instruction may enable sensitive data to be made available, but once the condition has been resolved, subsequent instructions may be speculatively executed without the conditional instruction presenting a high risk of sensitive data being made available, even if preceding instructions remain unresolved.

To provide one example, a conditional branch instruction may have a branch outcome depending on the outcome of a bounds check, and be followed by one or more load instructions for accessing sensitive data which should only be architecturally executed if the bounds check passes and the branch is not taken, whereas if the bounds check fails then the branch instruction may branch past the sensitive load instructions. Unrestricted speculative execution following the conditional branch instruction may result in the load instructions being speculatively executed (e.g., if the branch is predicted not taken, possibly as a result of training the branch predictor in advance to predict the branch as not taken) and hence allow sensitive data to be accessed. In comparison, if speculative execution following the branch instruction is only permitted once the condition has been resolved and it is known that the bounds check has not passed, then the load instructions may not be speculatively executed since speculative execution may proceed assuming the branch will be taken, and hence the sensitive data may not be accessed.

Examples of the present technique provide processing circuitry configured to perform data processing, and instruction decoding circuitry configured to decode instructions to control the processing circuitry to perform the data processing. The instruction decoding circuitry is responsive to a speculation barrier variant of a conditional instruction having an instruction outcome depending on a condition, to control the processing circuitry to, while the condition is not yet resolved, impose a speculation barrier requirement to restrict speculative handling of a subsequent operation appearing in program order after the speculation barrier variant of the conditional instruction. In some examples, speculative handling is restricted for all subsequent operations following the speculation barrier variant of the conditional instruction while the speculation barrier requirement is imposed. In response to resolution of the condition, the processing circuitry is configured to relax the speculation barrier requirement imposed by the speculation barrier variant of the conditional instruction.

The speculation barrier requirement can reduce the likelihood of subsequent instructions following the conditional instruction being speculatively executed on the basis of a predicted outcome of the conditional instruction in a way which may enable sensitive information to be made available to an attacker. However, once the condition of the conditional instruction has been resolved, speculative execution of subsequent instructions may be permitted because the risk posed by speculative execution of the conditional instruction may have passed. Hence, the conditional instruction may provide little risk once the condition has been resolved. Whilst the speculation barrier requirement is imposed, performance may be affected due to the restriction on speculative handling of subsequent instructions. Therefore, relaxing the speculation barrier requirement in response to resolution of the condition may enable performance to be improved without increasing the risk of sensitive data being made available to speculative side-channel attacks.

In some examples, the processing circuitry may be configured to relax the speculation barrier requirement in response to resolution of the condition and thereby permit speculative handling of the subsequent operations which would have otherwise been restricted by the speculation barrier requirement, even if an earlier instruction preceding the speculation barrier variant of the conditional instruction in program order has not yet been architecturally resolved.

Hence, even if the conditional instruction is itself on a speculative program path and is therefore preceded in program order by one or more architecturally unresolved instructions, speculative handling of subsequent operations may be permitted following resolution of the condition. Therefore, the speculation barrier variant of the conditional instruction (unlike a global speculation barrier instruction) may not prohibit all speculative execution of subsequent instructions until all earlier instructions have been resolved, but rather enable speculative execution of subsequent instructions once the barrier is relaxed even if there are unresolved preceding instructions, therefore enabling performance to be improved compared to the use of a stricter non-conditional speculation barrier instruction. For example, a programmer could use the speculation barrier variant of the conditional instruction in cases where it is known that speculation of earlier instructions may not allow sensitive information to be made available, but that there is a risk that speculation of the conditional instruction could be used to access sensitive information and hence the speculation barrier variant of the conditional instruction can be used to provide limited restriction on speculative execution specific to the conditional instruction.

As the speculation barrier variant of the conditional instruction may itself be on a speculative path, it will be appreciated that resolution of the condition does not necessarily require the conditional instruction to be architecturally resolved. All that is required for the speculation barrier requirement to be relaxed is that the outcome of the condition is known, so that the outcome of the condition is not being speculated in any subsequent speculative execution.

The condition may be specified in different ways. In some examples, the encoding of the instruction may specify the condition for controlling the outcome of that instruction (e.g., a field in the instruction may identify whether the condition looks for a particular condition code), or the condition may be implicit in the instruction type, for example.

In some examples, the processing circuitry may be configured to relax the speculation barrier requirement in response to resolution of the condition regardless of an outcome of the condition. Speculation of the outcome of the condition may enable sensitive data to be made available to an attacker. However, once the condition is resolved one way or another then speculation of the outcome is no longer possible and hence the risk of sensitive data being accessed may be reduced. In the bounds check example given above, if it is known that the bounds check will pass then there is no risk in allowing speculative execution of the load instructions for accessing sensitive data as it is known that those instructions will be permitted to access the data, and likewise if the bounds check does not pass then there is no risk in allowing speculative execution of the instructions down the taken branch of the instruction, bypassing the sensitive load instructions, as it is known that the sensitive load instructions should not be speculatively executed. Therefore, relaxing the speculation barrier requirement once the condition is resolved may provide a sufficient security guarantee regardless of the outcome of the condition.

Whether or not a particular conditional instruction is a speculation barrier variant may be determined in various ways.

In some examples, the instruction decoding circuitry may be configured to determine that a given conditional instruction is the speculation barrier variant based on an encoding of the given conditional instruction. For example, the opcode of the instruction may indicate that the given instruction is a speculation barrier variant of a particular conditional instruction. Alternatively, a field may be set in the encoding of the instruction indicating that the instruction is a speculation barrier variant of the conditional instruction identified by the opcode.

In other examples, the encoding of the conditional instruction itself may be unchanged, and the instruction decoding circuitry may be configured to determine that a given conditional instruction is the speculation barrier variant in response to detecting that the given conditional instruction is preceded in program order by a speculation barrier prefix instruction. That is, a pair of instructions comprising the speculation barrier prefix instruction followed by the conditional instruction may be interpreted by the instruction decoding circuitry as the speculation barrier variant of the conditional instruction. Providing the speculation barrier prefix instruction may provide a more efficient encoding. For example, a single speculation barrier prefix instruction may be defined rather than providing unique opcodes for speculation barrier variants of several conditional instructions. Further, use of the speculation barrier prefix instruction reduces the requirement to encode further information such as a “speculation barrier variant” field in an already restricted instruction encoding.

In some examples, the speculation barrier prefix instruction may be interpreted as a no operation (NOP) instruction by an instruction decoder not supporting the speculation barrier prefix instruction. Encoding the speculation barrier prefix instruction in the NOP space supports backwards compatibility with processors not supporting the speculation barrier variant of the conditional instruction, as a program in which the speculation barrier prefix instructions cause no operation to be performed may be executed in the same way as a program in which the speculation barrier variant of the conditional instruction is not used at all.

The speculation barrier requirement may be provided in several ways. In general, the speculation barrier requirement may reduce the likelihood of sensitive information being made available to an attacker due to speculative handling of operations subsequent in program order to the speculation barrier variant of the conditional instruction.

In some examples, the processing circuitry may impose a speculation barrier requirement to prevent a subsequent operation from speculatively influencing allocation of entries in a cache, at least where said allocation could be indicative of a data value in memory or a data value in a register. The influence over allocations of entries in the cache could be the allocation of a new entry for a given address which did not previously have an entry allocating the cache, or the eviction of a previously cached entry associated with a given address so that the given address is no longer cached. As will be discussed in more detail below, influencing allocation of data in a cache is one mechanism by which speculative execution of instructions can make sensitive information externally visible to an attacker. However, by restricting the ability of speculative handling of operations to allocate entries in a cache, then even if speculative handling of instructions is permitted, this may suppress the risk of sensitive information accessed during speculative handling being made externally visible to an attacker. In some cases, all speculative handling of operations may be prevented from speculatively influencing allocation of entries in a particular cache. However, in other examples, only speculative allocation of entries which may be indicative of a data value in memory or a register may be prevented, as this may allow improved performance compared to completely preventing speculative allocation, whilst still protecting sensitive information in memory or registers.

The processing circuitry may prevent the subsequent operation from speculatively influencing allocation into one or more different types of cache. In some examples, the cache may comprise a data or an instruction cache (or a cache, such as a level two cache, which stores both data and instructions). For example, a processor could speculatively access a pattern of memory addresses dependent on sensitive information, causing cache entries to be allocated in a data cache or instruction cache for data or instructions stored at the speculatively accessed addresses corresponding to the sensitive information, so that less privileged code which does not have access to that sensitive information can use cache timing side-channels to probe which addresses have been allocated to, or evicted from, the data or instruction cache by the more privileged code, to give some information which could allow the sensitive information to be deduced. Hence, a speculation barrier requirement comprising preventing the subsequent operation from speculatively influencing allocation of entries into a data cache or instruction cache may reduce the likelihood of sensitive data being made available via a side-channel attack.

Side-channel attacks may derive sensitive information from one or more further types of cache. For example, an address translation cache may cache address translation information corresponding to recently translated virtual addresses. Speculative execution of instructions may cause virtual addresses derived from sensitive information to be translated, hence causing entries in an address translation cache to be allocated for addresses indicative of the sensitive information. Presence of certain entries in the address translation cache could be probed by determining how quickly address translations are returned for a range of test addresses, and hence sensitive information may be derived from an address translation cache. Hence, in some examples the cache may comprise an address translation cache.

Other examples of the cache could include: a branch prediction cache, a value predictor cache, a load/store aliasing predictor cache, and other predictive structures.

There may be different ways in which the processing circuitry may prevent the subsequent operation following the speculation barrier variant of the conditional instruction from speculatively influencing allocations of entries in the cache. In some examples, the processing circuitry may prevent the subsequent operation from speculatively influencing allocations of entries in the cache while permitting speculative execution of the subsequent operation. In other examples, the processing circuitry may prevent speculative execution of the subsequent operation, at least until the condition is resolved, to prevent speculative handling of the subsequent operation from speculatively influencing allocation of entries in the cache.

In some examples, the speculation barrier requirement may comprise controlling the processing circuitry to prevent the subsequent operation being speculatively executed using at least one of: a predicted data value, a predicted condition code for an unresolved earlier instruction, other than a conditional branch instruction, preceding the speculation barrier variant of the conditional instruction in program order, and a prediction of predicate information indicative of which data elements of a vector value are active elements for a vector processing instruction. By preventing subsequent instructions being able to speculatively use the outcome of data value prediction, condition code prediction or predicate prediction made for an instruction preceding the speculation barrier variant of the conditional instruction, this can reduce the avenues by which sensitive information can be made available for the attacker.

In some examples, the speculation barrier requirement may comprise preventing speculative execution of any subsequent operation appearing in program order after the speculation barrier variant of the conditional instruction. Preventing speculative execution of any subsequent operation may provide a strong guarantee that sensitive information cannot be made available via speculative execution following the speculation barrier variant of the conditional instruction. Whilst the performance impact of preventing any speculative execution following the conditional instruction may appear significant, this speculation barrier requirement is relaxed in response to resolution of the condition of the conditional instruction, and hence use of the speculation barrier variant of the conditional instruction may provide a significantly reduced performance impact, whilst still providing a strong security guarantee.

The condition of the conditional instruction is not particularly limited. In some examples, the condition may depend on the outcome of a comparison between values. Such a comparison could be used to determine whether the conditional instruction should have a first outcome or a second outcome. For example, the condition may comprise checking whether an address to be accessed is within the bounds of a protected region of memory, checking whether any more iterations of a loop should be performed, and so on.

In some examples, evaluating the condition may comprise testing whether at least one condition code in a status register satisfies the condition. The condition may evaluate the outcome of a compare instruction preceding the speculation barrier variant of the conditional instruction in program order, where the compare instruction sets condition codes depending on the outcome of the comparison (e.g., to indicate whether a first value is larger than, smaller than, or equal to a second value). Hence, the processing circuitry may not perform the comparison in response to the conditional instruction itself but in response to a preceding instruction. In other examples, however, the processing circuitry may perform a comparison to evaluate the condition in response to the conditional instruction itself.

The type of conditional instruction is not particularly limited, and speculation barrier variants of several conditional instructions may be provided. In some examples, the conditional instruction may comprise a conditional branch instruction having a branch outcome, e.g., whether the branch is taken or not taken, depending on the condition. A conditional branch instruction may be at risk of allowing sensitive information to be made available, for example when the branch instruction is used to implement bounds checks for controlling access to memory, and hence providing a speculation barrier variant of the conditional branch instruction may enable security to be improved whilst reducing performance impact. In other examples, the conditional instruction may comprise a conditional select instruction configured to select an output value between two or more input values depending on the condition. Speculative execution of the conditional select instruction may, similarly to the conditional branch instruction, allow sensitive information to be made available, and hence a speculation barrier variant of the conditional select instruction may be provided.

In some examples, the conditional branch instruction may comprise a compare-and-branch instruction, and the processing circuitry may be responsive to the compare-and-branch instruction to perform a comparison to evaluate the condition. The comparison may for example not update condition flags.

In some examples, the apparatus may comprise prediction circuitry to predict an outcome of a given instruction in advance of execution of the given instruction. The prediction circuitry may be configured to not incur prediction resource for predicting the instruction outcome of the speculation barrier variant of the conditional instruction. Prediction resource may include, for example, entries in a prediction structure. There may be limited performance improvement to be gained by predicting the outcome of the speculation barrier variant of the conditional instruction, since speculative execution on the basis of such a prediction may be limited. By the time speculative execution may be allowed, this will be on the basis of the condition being resolved, and hence a prediction of the condition may have limited value. Hence, reducing use of prediction resource for predicting the outcome of the speculation barrier variant of the conditional instruction may have little effect on performance whilst allowing the prediction resource to be used for predicting other instructions where such prediction may benefit performance.

Particular examples will now be described with reference to the Figures.

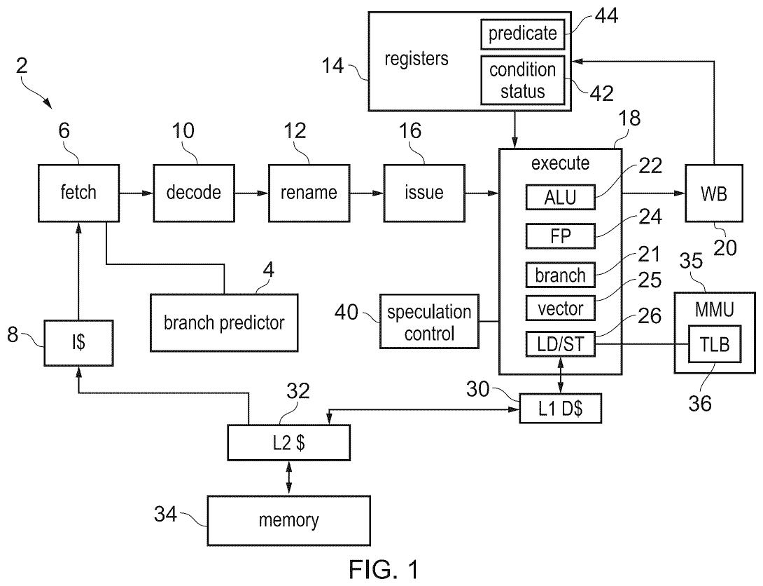

FIG. 1 schematically illustrates an example of a data processing apparatus 2 having a processing pipeline comprising a number of pipeline stages. The pipeline includes a branch predictor 4 for predicting outcomes of branch instructions. A fetch stage 6 generates a series of fetch addresses based on the predictions made by the branch predictor 4. The fetch stage 6 fetches the instructions identified by the fetch addresses from an instruction cache 8. A decode stage 10 decodes the fetched instructions to generate control information for controlling the subsequent stages of the pipeline. A rename stage 12 performs register renaming to map architectural register specifiers identified by the instructions to physical register specifiers identifying registers 14 provided in hardware. Register renaming can be useful for supporting out-of-order execution as this can allow hazards between instructions specifying the same architectural register to be eliminated by mapping them to different physical registers in the hardware register file, to increase the likelihood that the instructions can be executed in a different order from their program order in which they were fetched from the cache 8, which can improve performance by allowing a later instruction to execute while an earlier instruction is waiting for an operand to become available. The ability to map architectural registers to different physical registers can also facilitate the rolling back of architectural state in the event of a branch misprediction. An issue stage 16 queues instructions awaiting execution until the required operands for processing those instructions are available in the registers 14. An execute stage 18 executes the instructions to carry out corresponding processing operations. A writeback stage 20 writes results of the executed instructions back to the registers 14.

The execute stage 18 may include a number of execution units such as a branch unit 21 for evaluating whether branch instructions have been correctly predicted, an ALU (arithmetic logic unit) 22 for performing arithmetic or logical operations, a floating-point unit 24 for performing operations using floating-point operands, a vector processing unit 25 for processing vector operations where multiple independent data elements are processed in response to a single instruction, and a load/store unit 26 for performing load operations to load data from a memory system to the registers 14 or store operations to store data from the registers 14 to the memory system. In this example the memory system includes a level one instruction cache 8, a level one data cache 30, a level two cache 32 which is shared between data and instructions, and main memory 34, but it will be appreciated that this is just one example of a possible memory hierarchy and other implementations can have further levels of cache or a different arrangement. Access to memory may be controlled using a memory management unit (MMU) 35 for controlling address translation and/or memory protection. The load/store unit 26 may use a translation lookaside buffer (TLB) 36 of the MMU 35 to map virtual addresses generated by the pipeline to physical addresses identifying locations within the memory system. It will be appreciated that the pipeline shown in FIG. 1 is just one example and other examples may have different sets of pipeline stages or execution units. For example, an in-order processor may not have a rename stage 12.

The branch predictor 4 is one example of a speculation mechanism which may be used by the data processing apparatus to speculatively perform data processing operations before it is known whether they are really required, based on a prediction of a branch outcome for a conditional branch instruction and/or a prediction of a target address for an indirect branch instruction. There may also be speculation control circuitry 40 associated with the execute unit 18 for controlling the execute stage to speculatively execute instructions based on a prediction (other than the branch prediction) of information associated with that instruction.

For example, a conditional instruction may control the execute stage 18 to perform a conditional processing operation, conditional on the values of condition status codes 42 which are stored in the registers 14. Some condition-setting instructions may cause the condition status codes 42 to be updated based on the result of the instruction. For example, an arithmetic instruction processed by the ALU 22 could cause the condition codes 42 to be updated to indicate a property of the result, such as: whether the result of an arithmetic operation was zero; whether the result was negative, or whether the operation generated a signed overflow or unsigned overflow. Subsequent conditional instructions may then test whether the current values of the condition status codes 42 meet some test condition. From an architectural point of view, if the codes do meet the test condition then an associated processing operation (such as an arithmetic or logical operation) may be performed, while if the condition status codes 42 do not meet the test condition then that conditional operation may not be performed and instead the instruction may be treated as a no-operation instruction which has no architectural effect. However, in the micro-architecture the speculation control circuitry 40 may speculatively execute the processing operations associated with the conditional instruction based on a prediction of the condition status codes 42, before the actual condition codes are known, to avoid waiting for earlier instructions to complete which may change the condition codes. If the prediction turns out to be incorrect, then the results of the speculatively executed instructions can be discarded and program flow can be rewound to the last correct point of execution.

Another form of speculation which could be performed by the speculation control circuitry 40 could be prediction of a predicate value 44 associated with a vector introduction executed by the vector processing unit 25. A vector instruction, also known as a SIMD (single instruction multiple data) instruction, may operate on multiple data elements stored within the same register. For example a vector add instruction may trigger the vector processing unit to perform multiple add operations, each of those add operations adding a respective pair of data elements at corresponding positions of two vector registers, to produce a corresponding result element which is to be written to a result vector register. This allows a number of independent additions to be carried out in response to one instruction. Vector instructions can be useful for allowing a scalar loop of processing instructions to be processed faster by allowing multiple iterations of the scalar loop to be processed in response to a single iteration of a vectorised loop of instructions including vector instructions to be executed by the vector processing unit 25.

Within a vectorised sequence of instructions, it could be desirable to include conditional functionality, so that if one element of the vector does not meet certain conditions, subsequent operations which would otherwise be performed on that element are not carried out, while other elements within the same vector may still be processed if they do meet the required condition. Also, when vectorising scalar loops, the number of iterations of the scalar loop may not map to an exact multiple of the number of elements provided in the vector, in which case there may be a loop tail iteration where some elements of the vector may not need to be processed, as there are not enough scalar iterations to fully populate the vector in the last vector loop iteration. Hence it can be useful to define a predicate value 44 which specifies which elements of a vector are active elements. Inactive elements of the result vector may be cleared to zero or could retain the previous value which was stored in those portions of the destination register prior to executing the instruction.

Hence, the predicate value 44 may need to be known before the outcome of the corresponding vector instruction can be determined. The predicate value 44 could be set by earlier instructions, e.g. conditional instructions that are waiting on the outcome of other instructions. Waiting for the predicate to actually be calculated may delay the vector instruction. If there is a prediction that can be made for the value of the predicate (e.g. based on previous instances of executing the same instructions, or on a default assumption that all elements are active), then the vector instruction can be executed speculatively to improve performance in the cases where the prediction is correct. If the prediction of the predicate later turns out to be incorrect then the processing can be rewound to an earlier point of execution discarding the results of any incorrectly speculated instructions. Hence, another form of speculation control may be to execute vector instructions speculatively based on a prediction of the predicate value 44.

Another form of speculation could be on the addresses of load or store instructions executed by the load/store unit. For example, where a load instruction follows an earlier store instruction or a store instruction follows an earlier load instruction, then the second instruction could be speculatively executed ahead of the first on the assumption that they will actually access different data values and so are independent, to improve performance in the case where the addresses do turn out to be different. However, if the speculation turns out to be incorrect and the second of the pair of instructions actually ends up accessing the same address as the first, then the speculation may be incorrect, which could result in one of the instructions providing the incorrect result. If a misspeculation is detected, processing can be rewound to an earlier point of execution.

Such speculation mechanisms could potentially be exploited by an attacker to gain access to sensitive information which the attacker should not be allowed to access. The processing apparatus may operate using a privilege based mechanism, in which the MMU 35 may define access permissions restricting access to particular regions of a memory address space to code executed at a given privilege level or higher. An attacker in control of unprivileged code could try to exploit cache timing side-channels to gain access to information on sensitive information in a privileged region of memory which the attacker does not have access to.

The basic principle behind cache timing side-channels is that the pattern of allocations into the cache, and, in particular, which cache sets have been used for the allocation, can be determined by measuring the time taken to access entries that were previously in the cache, or by measuring the time to access the entries that have been allocated. This then can be used to determine which addresses have been allocated into the cache.

By performing speculative memory reads to cacheable locations beyond an architecturally unresolved branch (or other change in program flow), the result of those reads can themselves be used to form the addresses of further speculative memory reads. These speculative reads cause allocations of entries into the cache whose addresses are indicative of the values of the first speculative read. This becomes an exploitable side-channel if untrusted code is able to control the speculation in such a way it causes a first speculative read of location which would not otherwise be accessible at that untrusted code.

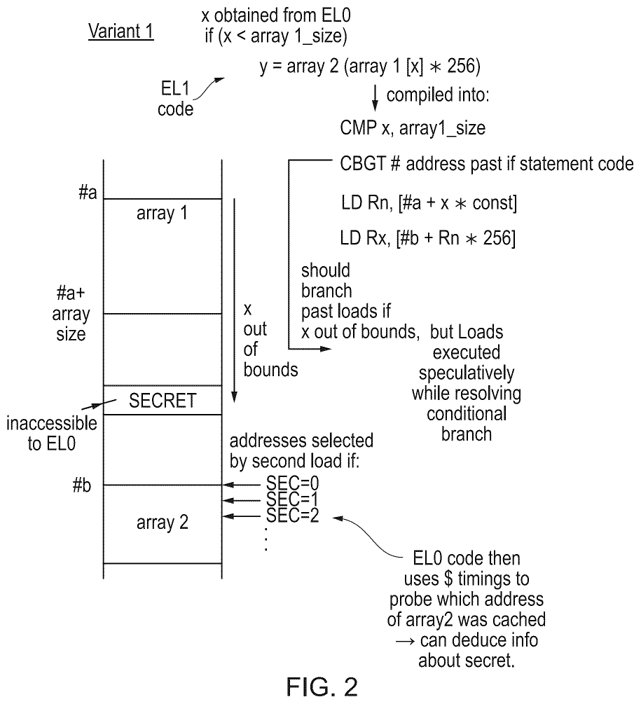

FIG. 2 shows a diagram illustrating this type of attack pictorially. In the example of FIG. 2 the variable x is obtained from untrusted code operating at a lower privilege level EL0. Variable y is loaded by code operating at a higher privilege level EL1 which is allowed to access secret information which is not accessible to ELO but which the attacker wishes to gain access to. Variable x is compared with a size parameter indicating the size of array 1, and a conditional branch will branch past the subsequent load instructions LD if the untrusted parameter is greater than the array size. However, these loads may be speculatively executed assuming that the conditional branch will determine a not-taken outcome, even if subsequently it is determined that the untrusted variable x was out of range. This may allow a load to an out-of-bounds address #a+x to load secret information which the attacker should not have access to, if the attacker has chosen “x” in such a way to make #a+x map onto the address of the secret. The second load may then load a value from a second array, array 2, at an address selected based on part of the secret. This second load may cause a change in cache allocation which can then be exploited by less privileged code operating at the lower privilege level (EL0), which may use cache timing analysis to probe which particular address of the second array was cached and hence deduce information about the secret.)

Hence, the untrusted software can, by providing out-of-range quantities for the value x, access anywhere accessible to the supervisory software, and as such, this approach can be used by untrusted software to recover the value of any memory accessible by the supervisory software. Modern processors have multiple different types of caching, including instruction caches, data caches and branch prediction cache. Where the allocation of entries in these caches is determined by the value of any part of some data that has been loaded based on untrusted input, then in principle this side channel could be stimulated.

As a generalization of this mechanism, it should be appreciated that the underlying hardware techniques mean that code past a conditional instruction might be speculatively executed, and so any sequence accessing memory after a conditional instruction may be executed speculatively. In such speculation, where one value speculatively loaded is then used to construct an address for a second load or indirect branch that can also be performed speculatively, that second load or indirect branch can leave an indication of the value loaded by the first speculative load in a way that could be read using a timing analysis of the cache by code that would otherwise not be able to read that value. This generalization implies that many code sequences commonly generated will leak information into the pattern of cache allocations that could be read by other, less privileged software. The most severe form of this issue is that described earlier in this section, where the less privileged software is able to select what values are leaked in this way.

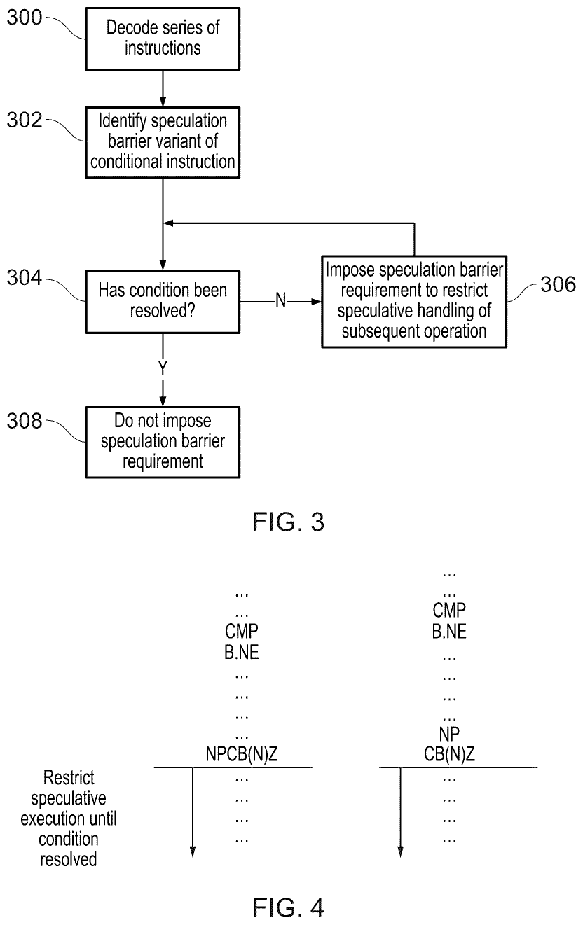

FIG. 3 is a flow diagram illustrating use of a speculation barrier variant of a conditional instruction. The speculation barrier variant of the conditional instruction can be used in programs in place of a typical conditional instruction, such as the conditional branch instruction CBGT in FIG. 2, to reduce the likelihood of sensitive information being made available to an attacker via the speculation-based attacks discussed above.

At step 300, the instruction decoder 10 decodes a series of instructions fetched by the fetch circuitry 6. At step 302 the instruction decoder identifies a speculation barrier variant of a conditional instruction in the series of fetched instructions. As illustrated in FIG. 4, the speculation barrier variant may be indicated in various ways.

The conditional instruction has an outcome which depends on a condition. At step 304 it is determined whether the condition has been resolved. For example, it may be determined whether the outcome of the instruction can be determined on the basis of the available information.

If the condition has not been resolved, then at step 306 the processing circuitry is configured to impose a speculation barrier requirement to restrict speculative handling of the subsequent operations following the speculation barrier variant of the conditional instruction in program order.

The speculation barrier requirement may take several forms, and generally may restrict sensitive information being made available via speculative execution of instructions.

In some examples, this may involve preventing any speculative execution of instructions following the speculation barrier variant of the conditional instruction whilst the speculation barrier requirement is imposed. In other examples, the barrier may not be so restrictive and some restricted speculative handling of subsequent operations may be permitted.

In some examples, the speculation barrier requirement may restrict access of speculatively executed instructions to sensitive information. For example, the speculation barrier requirement may prevent speculative execution of a given subsequent operation using any of: a predicted data value, a predicted condition code for an unresolved earlier instruction, other than a conditional branch instruction, preceding the speculation barrier variant of the conditional instruction in program order, and a prediction of predicate information indicative of which data elements of a vector value are active elements for a vector processing instruction.

Additionally or alternatively, handling of subsequent operations may be restricted to restrict whether those instructions can speculatively affect allocation of entries in a cache, thereby preventing sensitive information from being made available externally even if that information may be accessed during speculative execution.

After the speculation barrier requirement has been imposed, processing circuitry may monitor the condition to determine when the condition becomes resolved. Once the condition has been resolved, at step 308 the speculation barrier requirement is relaxed.

By relaxing the speculation barrier requirement in response to determining that the condition has been resolved, the performance impact of the speculation barrier requirement is reduced compared to examples in which the speculation barrier requirement is not relaxed. This can provide improved security with a reduced performance impact.

FIG. 4 illustrates two example programs comprising a speculation barrier variant of a conditional instruction. In particular, the conditional instruction in both examples is a compare-and-branch if zero CBZ (or compare-and-branch if not zero CBNZ) instruction which causes program flow to branch to a branch target address if a particular value to be tested is equal to zero (or not equal to zero for the CBNZ instruction).

The program illustrated on the left side of FIG. 4 includes a speculation barrier variant of the CB(N)Z instruction identified by its instruction encoding to be a speculation barrier variant (referred to in this example as a non-predicted variant) of the CB(N)Z instruction, NPCB(N)Z. This could for example be indicated by the opcode of the instruction or a field in the encoding of the instruction which identifies that it is an NP variant.

The program illustrated on the right side of FIG. 4 includes an NP variant of the CB(N)Z identified by the prefix instruction NP preceding the CB(N)Z instruction. The NP prefix instruction may be inserted into a program before conditional instructions such as the CB(N)Z instruction to indicate that the following instruction should not be predicted, but that speculative execution of following instructions should be permitted once the condition has been resolved.

As illustrated in both sides of FIG. 4, the instructions following the NP variant of the conditional instruction may not be permitted to be speculatively executed until the condition of the conditional instruction has been resolved (or at least speculative handling of those instructions may be restricted). However, once the condition has been resolved the NP variant may have no effect on speculative execution of subsequent instructions. For example, once the condition has been resolved, subsequent instructions in program order may be allowed to be speculatively executed even if instructions preceding the conditional instruction, such as the B.NE instruction illustrated in FIG. 4, have not yet been resolved and hence even if the conditional instruction is itself on an architecturally incorrect path.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

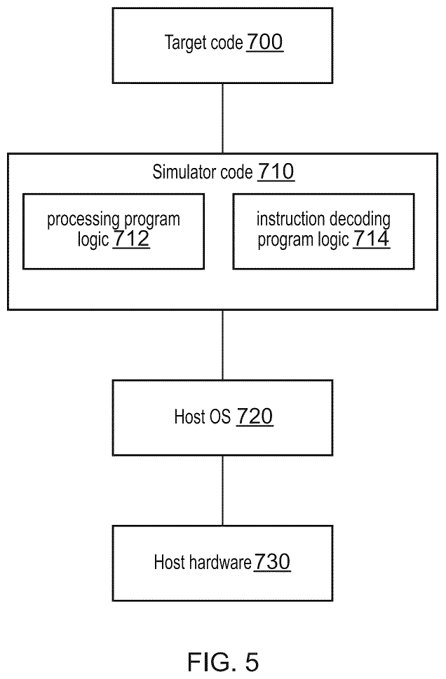

FIG. 5 illustrates a simulator implementation that may be used. Whilst the earlier described embodiments implement the present invention in terms of apparatus and methods for operating specific processing hardware supporting the techniques concerned, it is also possible to provide an instruction execution environment in accordance with the embodiments described herein which is implemented through the use of a computer program. Such computer programs are often referred to as simulators, insofar as they provide a software based implementation of a hardware architecture. Varieties of simulator computer programs include emulators, virtual machines, models, and binary translators, including dynamic binary translators. Typically, a simulator implementation may run on a host processor 730, optionally running a host operating system 720, supporting the simulator program 710. In some arrangements, there may be multiple layers of simulation between the hardware and the provided instruction execution environment, and/or multiple distinct instruction execution environments provided on the same host processor. Historically, powerful processors have been required to provide simulator implementations which execute at a reasonable speed, but such an approach may be justified in certain circumstances, such as when there is a desire to run code native to another processor for compatibility or re-use reasons. For example, the simulator implementation may provide an instruction execution environment with additional functionality which is not supported by the host processor hardware, or provide an instruction execution environment typically associated with a different hardware architecture. An overview of simulation is given in “Some Efficient Architecture Simulation Techniques”, Robert Bedichek, Winter 1990 USENIX Conference, Pages 53-63.

To the extent that embodiments have previously been described with reference to particular hardware constructs or features, in a simulated embodiment, equivalent functionality may be provided by suitable software constructs or features. For example, particular circuitry may be implemented in a simulated embodiment as computer program logic. Similarly, memory hardware, such as a register or cache, may be implemented in a simulated embodiment as a software data structure. In arrangements where one or more of the hardware elements referenced in the previously described embodiments are present on the host hardware (for example, host processor 730), some simulated embodiments may make use of the host hardware, where suitable.

The simulator program 710 may be stored on a computer-readable storage medium (which may be a non-transitory medium), and provides a program interface (instruction execution environment) to the target code 700 (which may include applications, operating systems and a hypervisor) which is the same as the interface of the hardware architecture being modelled by the simulator program 710. Thus, the program instructions of the target code 700, including may be executed from within the instruction execution environment using the simulator program 710, so that a host computer 730 which does not actually have the hardware features of the apparatus 2 discussed above can emulate these features. The simulator program 710 may include instruction decoding program logic 714 for decoding instructions of the target code 700 and mapping them to corresponding functionality executed using one or more instructions from the native instruction set supported by the host hardware 730, as well as processing program logic 712 for controlling the host hardware 730 to perform processing operations in response to instructions decoded by the decoding program logic 712.

Some examples are set out in the following clauses:
1. An apparatus, comprising:
   processing circuitry configured to perform data processing; and
   instruction decoding circuitry configured to decode instructions to control the processing circuitry to perform the data processing; in which:
   the instruction decoding circuitry is responsive to a speculation barrier variant of a conditional instruction having an instruction outcome depending on a condition, to control the processing circuitry to:
      while the condition is not yet resolved, impose a speculation barrier requirement to restrict speculative handling of a subsequent operation appearing in program order after the speculation barrier variant of the conditional instruction; and
      in response to resolution of the condition, relax the speculation barrier requirement imposed by the speculation barrier variant of the conditional instruction.
2. The apparatus according to clause 1, wherein the processing circuitry is configured to relax the speculation barrier requirement to permit speculative handling of the subsequent operation which would have been restricted by the speculation barrier requirement, even if an earlier instruction preceding the speculation barrier variant of the conditional instruction in program order has not yet been architecturally resolved.
3. The apparatus according to any preceding clause, wherein the processing circuitry is configured to relax the speculation barrier requirement in response to resolution of the condition regardless of an outcome of the condition.
4. The apparatus according to any preceding clause, wherein the instruction decoding circuitry is configured to determine whether a given conditional instruction is the speculation barrier variant based on an encoding of the given conditional instruction.
5. The apparatus according to any of clauses 1 to 3, wherein the instruction decoding circuitry is configured to determine that a given conditional instruction is the speculation barrier variant in response to detecting that the given conditional instruction is preceded in program order by a speculation barrier prefix instruction.
6. The apparatus according to any preceding clause, wherein the speculation barrier requirement prevents the subsequent operation from speculatively influencing allocation of entries in a cache, at least where said allocation could be indicative of a data value in memory or a register.
7. The apparatus according to clause 6, wherein said cache is at least one of:
   a data cache;
   an instruction cache;
   an address translation cache; and
   a branch prediction cache.
8. The apparatus according to any of clause 6 and clause 7, wherein the speculation barrier requirement permits speculative execution of the subsequent operation.
9. The apparatus according to any of clauses 1 to 7, wherein the speculation barrier requirement prevents the subsequent operation from being speculatively executed.
10. The apparatus according to any preceding clause, wherein the speculation barrier requirement prevents speculative execution of a given subsequent operation using any of:
   a predicted data value;
   a predicted condition code for an unresolved earlier instruction, other than a conditional branch instruction, preceding the speculation barrier variant of the conditional instruction in program order; and
   a prediction of predicate information indicative of which data elements of a vector value are active elements for a vector processing instruction.
11. The apparatus according to any of clauses 1 to 7, wherein the speculation barrier requirement prevents speculative execution of any subsequent operation appearing in program order after the speculation barrier variant of the conditional instruction.
12. The apparatus according to any preceding clause, wherein evaluating the condition comprises testing whether at least one condition code in a status register satisfies the condition.
13. The apparatus according to any preceding clause, wherein the conditional instruction comprises a conditional branch instruction having a branch outcome depending on the condition.
14. The apparatus according to clause 13, wherein the conditional branch instruction comprises a compare-and-branch instruction, and the processing circuitry is responsive to the compare-and-branch instruction to perform a comparison to evaluate the condition.
15. The apparatus according to any preceding clause, comprising prediction circuitry to predict an outcome of a given instruction in advance of execution of the given instruction, wherein the prediction circuitry is configured to not incur prediction resource for predicting the instruction outcome of the speculation barrier variant of the conditional instruction.
16. Computer-readable code for fabrication of the apparatus of any preceding clause.
17. A method, comprising:
   decoding instructions to control processing circuitry to perform data processing; and
   responsive to a speculation barrier variant of a conditional instruction having an instruction outcome depending on a condition:
      while the condition is not yet resolved, imposing a speculation barrier requirement to restrict speculative handling of a subsequent operation, appearing in program order after the speculation barrier variant of the conditional instruction; and
      in response to resolution of the condition, relaxing the speculation barrier requirement imposed by the speculation barrier variant of the conditional instruction.
18. A computer program for controlling a host data processing apparatus to provide an instruction execution environment, the computer program comprising:
   processing program logic configured to perform data processing; and
   instruction decoding program logic configured to decode instructions to control the processing program logic to perform the data processing; in which:
   the instruction decoding program logic is responsive to a speculation barrier variant of a conditional instruction having an instruction outcome depending on a condition, to control the processing circuitry to:
      while the condition is not yet resolved, impose a speculation barrier requirement to restrict speculative handling of a subsequent operation, appearing in program order after the speculation barrier variant of the conditional instruction; and
      in response to resolution of the condition, relax the speculation barrier requirement imposed by the speculation barrier variant of the conditional instruction.

In the present application, the words “configured to.” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: A, B and C” encompasses any of the following options: A alone (without B or C), B alone (without A or C), C alone (without A or B), A and B in combination (without C), A and C in combination (without B), B and C in combination (without A), or A, B and C in combination.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. An apparatus, comprising:
processing circuitry configured to perform data processing; and
instruction decoding circuitry configured to decode instructions to control the processing circuitry to perform the data processing; in which:
the instruction decoding circuitry is responsive to a speculation barrier variant of a conditional instruction having an instruction outcome depending on a condition for which evaluating the condition comprises testing whether at least one condition code in a status register satisfies the condition, to control the processing circuitry to:
while the condition is not yet resolved, impose a speculation barrier requirement to restrict speculative handling of a subsequent operation appearing in program order after the speculation barrier variant of the conditional instruction; and
in response to resolution of the condition and regardless of an outcome of the condition, relax the speculation barrier requirement imposed by the speculation barrier variant of the conditional instruction.

2. The apparatus according to claim 1, wherein the processing circuitry is configured to relax the speculation barrier requirement to permit speculative handling of the subsequent operation which would have been restricted by the speculation barrier requirement, even if an earlier instruction preceding the speculation barrier variant of the conditional instruction in program order has not yet been architecturally resolved.

3. (canceled)

4. The apparatus according to claim 1, wherein the instruction decoding circuitry is configured to determine whether a given conditional instruction is the speculation barrier variant based on an encoding of the given conditional instruction.

5. The apparatus according to claim 1, wherein the instruction decoding circuitry is configured to determine that a given conditional instruction is the speculation barrier variant in response to detecting that the given conditional instruction is preceded in program order by a speculation barrier prefix instruction.

6. The apparatus according to claim 1, wherein the speculation barrier requirement prevents the subsequent operation from speculatively influencing allocation of entries in a cache, at least where said allocation could be indicative of a data value in memory or a register.

7. The apparatus according to claim 6, wherein said cache is at least one of:
a data cache;
an instruction cache;
an address translation cache; and
a branch prediction cache.

8. The apparatus according to claim 6, wherein the speculation barrier requirement permits speculative execution of the subsequent operation.

9. The apparatus according to claim 1, wherein the speculation barrier requirement prevents the subsequent operation from being speculatively executed.

10. The apparatus according to claim 1, wherein the speculation barrier requirement prevents speculative execution of a given subsequent operation using any of:
a predicted data value;
a predicted condition code for an unresolved earlier instruction, other than a conditional branch instruction, preceding the speculation barrier variant of the conditional instruction in program order; and
a prediction of predicate information indicative of which data elements of a vector value are active elements for a vector processing instruction.

11. The apparatus according to claim 1, wherein the speculation barrier requirement prevents speculative execution of any subsequent operation appearing in program order after the speculation barrier variant of the conditional instruction.

12. (canceled)

13. The apparatus according to claim 1, wherein the conditional instruction comprises a conditional branch instruction having a branch outcome depending on the condition.

14. The apparatus according to claim 13, wherein the conditional branch instruction comprises a compare-and-branch instruction, and the processing circuitry is responsive to the compare-and-branch instruction to perform a comparison to evaluate the condition.

15. The apparatus according to claim 1, comprising prediction circuitry to predict an outcome of a given instruction in advance of execution of the given instruction, wherein the prediction circuitry is configured to not incur prediction resource for predicting the instruction outcome of the speculation barrier variant of the conditional instruction.

16. A non-transitory computer-readable medium storing computer-readable code for fabrication of the apparatus of claim 1.

17. A method, comprising:
decoding instructions to control processing circuitry to perform data processing; and
responsive to a speculation barrier variant of a conditional instruction having an instruction outcome depending on a condition for which evaluating the condition comprises testing whether at least one condition code in a status register satisfies the condition:
while the condition is not yet resolved, imposing a speculation barrier requirement to restrict speculative handling of a subsequent operation, appearing in program order after the speculation barrier variant of the conditional instruction; and
in response to resolution of the condition and regardless of an outcome of the condition, relaxing the speculation barrier requirement imposed by the speculation barrier variant of the conditional instruction.

18. A non-transitory computer-readable storage medium storing a computer program for controlling a host data processing apparatus to provide an instruction execution environment, the computer program comprising:
processing program logic configured to perform data processing; and
instruction decoding program logic configured to decode instructions to control the processing program logic to perform the data processing; in which:
the instruction decoding program logic is responsive to a speculation barrier variant of a conditional instruction having an instruction outcome depending on a condition for which evaluating the condition comprises testing whether at least one condition code in a status register satisfies the condition, to control the processing program logic to:
while the condition is not yet resolved, impose a speculation barrier requirement to restrict speculative handling of a subsequent operation, appearing in program order after the speculation barrier variant of the conditional instruction; and
in response to resolution of the condition and regardless of an outcome of the condition, relax the speculation barrier requirement imposed by the speculation barrier variant of the conditional instruction.
